(19) United States
(12) Patent Application Publication
(10) Pub. No.: US 2023/0276870 A1
(43) Pub. Date: Sep. 7, 2023

(54) FABRIC, METHOD FOR PRODUCING SAME AND CLOTHING ITEM USING SAME

(71) Applicant: KANEKA CORPORATION, Osaka (JP)

(72) Inventor: Wataru KAWAUCHI, Hyogo (JP)

(73) Assignee: KANEKA CORPORATION, Osaka (JP)

(21) Appl. No.: 18/043,713

(22) PCT Filed: May 26, 2021
(86) PCT No.: PCT/JP2021/019983

§ 371 Date: Mar. 1, 2023

(30) Foreign Application Priority Data
Sep. 16, 2020 (JP) 2020-155031

(51) Int. Cl. A41D 13/008; A62B 17/00; D01F 6/54; D03D 15/208; D03D 15/283; D06P 3/72; D06P 3/76

(52) U.S. Cl. CPC A41D 13/008; A62B 17/003; D01F 6/54; D03D 15/208; D03D 15/283; D06P 3/72; D06P 3/76

(57) ABSTRACT

The present invention relates to a fabric containing a modacrylic fiber A and a cellulosic fiber, wherein the modacrylic fiber A contains an infrared absorber inside the fiber, and the fabric is dyed with at least a yellow cationic dye, a yellow reactive dye, and a yellow disperse dye. The fabric can be produced by dyeing a fabric containing a modacrylic fiber A and a cellulosic fiber with a cationic dye, a reactive dye, and a disperse dye to exhibit a fluorescent yellow color. Accordingly, it is possible to provide a fabric with excellent arc resistance and visibility, a method for producing the same, and a clothing item using the same.

### TECHNICAL FIELD

The present invention relates to a fabric containing a modacrylic fiber and having arc resistance and high visibility, a method for producing the same, and a clothing item using the same.

### BACKGROUND ART

In recent years, many accidents caused by arc flash have been reported, and, to prevent the danger of arc flash, there is a need to impart arc resistance to clothing worn by workers such as electrical mechanics and factory workers who work in environments where there is a risk of exposure to electrical arcs. For example, Patent

Document 1 describes a fabric for arc protective clothing, constituted by n modacrylic fiber containing an infrared absorber. Furthermore, the arc protective clothing is desired to have high visibility that makes it easy for a worker wearing this clothing to be detected by others. For example, Patent Document 2 describes dyeing a fiber or a fabric to impart visibility to a flame-retardant fabric for use in protective clothing, containing a synthetic cellulose fiber, a modacrylic fiber, and a para-aramid fiber.

### CITATION LIST

### Patent Documents

Patent Document 1: WO 2016/111116

Patent Document 2: JP 2010-502849A

### DISCLOSURE OF INVENTION

### Problem to be Solved by the Invention

However, the inventors of the present invention found that the modacrylic fiber described in Patent Document 1 is blue because it contains an infrared absorber, and thus, when dyed fluorescent yellow in the same way as for ordinary modacrylic fibers for high visibility, the fiber may become fluorescent green, and is likely to become fluorescent green (have low light fastness) especially after a xenon light fastness test. Furthermore, in Patent Document 2, the performance of arc resistance is controlled by adjusting the amount of para-aramid fibers added, and there is a problem in that a too large amount of para-aramid fibers increases the arc resistance but makes the fabric stiff and a too small amount of para-aramid fibers decreases the arc resistance. Meanwhile, synthetic cellulose and modacrylic fibers are used from the viewpoint of imparting visibility, but the amount of these fibers has to be increased to achieve high visibility, and there was room for improvement from the viewpoint of compatibility with arc resistance. Furthermore, the method of performing post-treatment (e.g., printing) on a fabric to obtain high visibility has issues from the viewpoint of durability (e.g., rubbing fastness).

In order to solve the above-described issues in conventional techniques, the present invention can provide a fabric with arc resistance, high visibility, and excellent fastness, a method for producing the same, and a clothing item using the same.

Means for Solving Problem

One or more embodiments of the present invention are directed to a fabric containing a modacrylic fiber A and a cellulosic fiber, wherein the fabric is dyed with at least a cationic dye, a reactive dye, and a disperse dye that are all yellow fluorescent dyes.

One or more embodiments of the present invention are directed to a clothing item containing the fabric.

One or more embodiments of the present invention are directed to a method for producing the fabric, including dyeing a fabric containing a modacrylic fiber A and a cellulosic fiber with a cationic dye, a reactive dye, and a disperse dye that are all yellow fluorescent dyes.

### Effects of the Invention

According to the present invention, it is possible to provide a fabric with arc resistance, high visibility, and excellent fastness, a method for producing the same, and a clothing item using the same.

### DESCRIPTION OF THE INVENTION

The inventors of the present invention conducted an in-depth study and found that dyeing a fabric containing a modacrylic fiber containing an infrared absorber and a cellulosic fiber with a predetermined dye makes it possible to obtain a fabric with arc resistance, high visibility, and excellent fastness.

### Arc Resistance

Arc resistance is evaluated as an ATPV (Arc Thermal Performance Value), and the ATPV is measured through an arc test based on the standard ASTM F1959/F1959M-12 (Standard Test Method for Determining the Arc Rating of Materials for Clothing).

The fabric according to one or more embodiments of the present invention preferably has an ATPV of 8 cal/cm² or more as measured according to ASTM F1959/F1959M-12, at a basis weight (fabric weight (ounces) per unit area (1 square yard)) of 6.5 oz/yd² or less.

The fabric according to one or more embodiments of the present invention has a basis weight of preferably 3 to 10 oz/yd², more preferably 4 to 9 oz/yd², and even more preferably 4 to 8 oz/yd², from the viewpoint of reducing the weight while maintaining arc resistance. If the basis weight is within the above-mentioned range, it is possible to obtain a lightweight clothing item with excellent workability.

Note that, in this specification, the range indicated by “. . . to . . . ” is the same as that indicated by “. . . or more and . . . or less”.

### Visibility

In one or more embodiments of the present invention, “high visibility” means those that are fluorescent yellow and conform to the standard “5.1 Colour performance requirements” of “ISO 20471:2013”. Furthermore, it means those that have high light fastness, and have “high visibility” even after a xenon light fastness test, specifically, those that are fluorescent yellow and conform to the standard “5.2 Colour after Xenon test” of “ISO 20471:2013”, even after a xenon light fastness test. That is to say, the two standards are both mean those that have color coordinates (x, y) located within the range of (0.387, 0.610), (0.356, 0.494), (0.398, 0.452), and (0.460, 0.540) (fluorescent yellow), and have a brightness factor β of 0.70 or more.

The fabric according to one or more embodiments of the present invention can obtain high visibility through dyeing with a predetermined dye. Ordinary modacrylic fibers are white, and thus, when dyed with a yellow dye to exhibit a fluorescent yellow color, the fibers can obtain the desired color, but the modacrylic fibers A are blue because they contain an infrared absorber, and thus when dyed with a yellow dye to exhibit a fluorescent yellow color for high visibility, the fibers may become fluorescent green. Thus, the modacrylic fibers A are made into a fabric together with cellulosic fibers and dyed with a predetermined yellow dye described below to obtain a fabric with high visibility that conforms to the 5.1 and 5.2 standards of “ISO 204712013” and the like. Furthermore, since a colorant is not attached to the fabrics through post-treatment, there is no loss of rubbing fastness.

### Dyeing

In order to obtain a fabric that exhibits a fluorescent yellow color, in particular, a fluorescent yellow color even after a light fastness test, cationic dyeing, reactive dyeing, and disperse dyeing are performed as three types of dyeing. There is no particular limitation on the dyeing order among cationic dyeing, reactive dyeing, and disperse dyeing, and dyeing in three baths or two baths is also acceptable. For example, cationic dyeing is performed first, followed by reactive dyeing, and finally by disperse dyeing. The temperature for dyeing is preferably from 30 to 100° C., and more preferably from 35 to 98° C. Furthermore, the holding time at that temperature is preferably from 1 to 180 minutes, and more preferably from 5 to 150 minutes.

Cationic dyeing is a commonly used method for dyeing modacrylic fibers.

There is no particular limitation on the cationic dye, as long as it is a yellow fluorescent dye, and examples thereof include Astrazon Flavine 10GFE 300%, Astrazon Yellow 8GSL 200%, and Astrazon Yellow 7GLL 200% manufactured by Dystar. These cationic dyes may be used alone or in a combination of two or more.

Reactive dyeing refers to a dyeing method in which a fiber to be dyed such as a cellulosic fiber is dyed through covalent bonding caused by a chemical reaction between a functional group such as a hydroxyl group, an amino group, an amide group, or a carboxy group of the fiber and triazine chloride or ethyl sulfone ester of a reactive dye, for example. There is no particular limitation on the reactive dye, as long as it is a yellow fluorescent dye, and examples thereof include Remazol Luminus Yellow FL, Remazol Yellow GG 150%, and Remazol Yellow GL 150% manufactured by Dystar. These reactive dyes may be used alone or in a combination of two or more.

Disperse dyeing refers to a method in which a fiber is physically dyed with a water-insoluble disperse dye dispersed in water. There is no particular limitation on the disperse dye, as long as it is a yellow fluorescent dye, and examples thereof include Terasil Flavine 10GFF, Dianix Yellow AC-E, and Dianix Yellow UN-SE manufactured by Dystar. These disperse dyes may be used alone or in a combination of two or more.

In addition to the dyes, dyeing auxiliaries such as a fluorescent whitening agent, a dye accelerant, a pH adjuster, and a leveling agent may be used to the extent that they do not adversely affect the dyeing.

A fluorescent whitening agent is a dye that absorbs ultraviolet light and emits fluorescence of 400 to 450 nm, which compensates for the yellow absorption by fluorescence, increasing reflection and making a fabric appear white and brilliant. There is no particular limitation on the fluorescent whitening agent, but examples thereof include Uvitex AC Liq manufactured by Huntsman.

A dye accelerant is an agent that swells the fiber to make it easier for dyes and chemicals to penetrate into the fiber, and is used to make dyeing easier. There is no particular limitation on the dye accelerant, and examples thereof include Tanavol-Dap (manufactured by Tanatex).

A pH adjuster is used to adjust pH, and there is no particular limitation thereon, and examples thereof include Ultra MT110 (manufactured by Mitejima Chemical Co., Ltd.).

A leveling agent is an auxiliary agent to prevent uneven dyeing and is used to dye a fabric uniformly. There is no particular limitation on the leveling agent, and examples thereof include Invalon NA (manufactured by Huntsman).

Furthermore, from the viewpoint of improving the physical properties and the dyeability, sodium salts such as sodium nitrate and sodium carbonate, calcium salts, and alkali salts may be added to the extent that they do not adversely affect the dyeing.

Furthermore, a fabric after dyeing may be bleached to improve whiteness, and there is no particular limitation on the bleaching agent, and examples thereof include Nichilon White WX Liquid (manufactured by Nissei Kasei Co., Ltd.). However, bleaching a fabric before dyeing is not preferable because it makes it difficult to obtain the desired fluorescent yellow color.

In one or more embodiments of the present invention, if the fabric is dyed with the above-described three types of dyes, a dye used for dyeing can be confirmed, for example, by the following method. The subject fabric is immersed in pyridine to extract the dye. When the dye is extracted, the pyridine turns yellow because the dye dissolves in the pyridine. The fact that a dye is found to be extracted means that the fabric is dyed with any one of the fluorescent yellow disperse dye, the fluorescent yellow cationic dye, and the fluorescent yellow reactive dye. Next, toluene and water are added to the extracted dye, and the mixture is shaken and allowed to stand to separate into two layers, whereby the upper layer (toluene layer) contains the disperse dye and the lower layer (water layer) contains the cationic dye and reactive dye. The toluene layer that is the upper layer is extracted, and the liquid is concentrated to see whether or not a disperse dye is contained, according to JIS L 1065.

### Fastness

Fastness is an index to measure the resistance of a fabric dyed with a dye or the like, and is an indicator of the resistance of a fabric to color change and color fading, and the test method is defined in the JIS standard. Usually, the fastness value is expressed from grade 1 to 5 in half-grade increments, with a higher grade value indicating better fastness and a lower grade value indicating poorer fastness.

Since the above-described dyeing is performed, the fabric according to one or more embodiments of the present invention is good in terms of not only light fastness but also other fastnesses such as rubbing fastness, and thus the fabric has excellent durability when used as a clothing item. The fabric has a rubbing fastness of preferably grade 4.5 or higher in a dry test and a rubbing fastness of preferably grade 3.5 or higher in a wet test as measured according to the test method for rubbing fastness defined in JIS L 0849.

### Modacrylic Fibers A

In one or more embodiments of the present invention, the modacrylic fibers A contain an infrared absorber inside the fibers. The infrared absorber contained in the modacrylic fibers A adjusts the reflection and/or absorption of light and imparts arc performance to the modacrylic fibers A, and thus a fabric containing the modacrylic fibers A has arc resistance. The arc resistance can be measured as described above. Furthermore, since the modacrylic fibers A contain an infrared absorber, the fibers have a high infrared-absorbing capacity, and a fabric with a heat shielding rate of less than 40% can be obtained. The heat shielding rate is a value obtained by evaluating the fabric based on a commonly used heat shielding test. From the viewpoint of realizing all arc resistance, infrared-absorbing functions, and spinnability, the modacrylic fibers A preferably contain the infrared absorber in an amount of 1 to 30% by weight with respect to the total weight of the modacrylic fibers. From the viewpoint of improving the arc resistance and the infrared-absorbing functions, the modacrylic fibers A contain the infrared absorber in an amount of more preferably 2% by weight or more, even more preferably 3% by weight or more, and even more preferably 4% by weight or more, with respect to the total weight of the modacrylic fibers. From the viewpoint of spinnability, the modacrylic fibers contain the infrared absorber in an amount of more preferably 20% by weight or less, even more preferably 15% by weight or less, and even more preferably 10% by weight or less, with respect to the total weight of the modacrylic fibers.

Furthermore, in the modacrylic fibers A, the infrared absorber is present inside the modacrylic fibers, resulting in a better texture and higher fastness compared to the case where the infrared absorber is attached to the fiber surface. Since the infrared absorber is added to the spinning dope and mixed before spinning, the infrared absorber is easily dispersed uniformly in the resulting fibers, and a binder or the like for dispersion is not necessary, and thus the texture is not impaired. On the other hand, when the infrared absorber is attached to the fiber surface, since it is applied to the fibers or fabric through post-treatment such as printing, permeation to the inside is difficult, and thus the infrared absorber tends to adhere more on the surface and also tends to fall off. In addition, because a binder or the like is used for attachment, the resulting fibers or fabric tends to be stiff and have a poor texture.

From the viewpoint of spinnability, cost, and uniformity of arc resistance, the modacrylic fibers A are preferably a non-conjugated fiber and the infrared absorber is preferably dispersed throughout the fiber interior.

There is no particular limitation on the infrared absorber, as long as it has an infrared-absorbing effect. For example, the infrared absorber preferably has an absorption peak in a wavelength region of 750 to 2500 nm. Specific examples thereof include antimony-doped tin oxide, indium tin oxide, niobium-doped tin oxide, phosphorus-doped tin oxide, fluorine-doped tin oxide, antimony-doped tin oxide supported on a titanium oxide substrate, iron-doped titanium oxide, carbon-doped titanium oxide, fluorine-doped titanium oxide, nitrogen-doped titanium oxide, aluminum-doped zinc oxide, and antimony-doped zinc oxide. Indium tin oxide includes indium-doped tin oxide and tin-doped indium oxide. From the viewpoint of improving the arc resistance and the infrared-absorbing capacity, the infrared absorber is preferably a tin oxide-based compound, and more preferably one or more selected from the group consisting of antimony-doped tin oxide, indium tin oxide, niobium-doped tin oxide, phosphorus-doped tin oxide, and fluorine-doped tin oxide. Furthermore, the use of the above-mentioned infrared absorbers is preferable because it increases the arc resistance and the infrared-absorbing capacity, and also can make the modacrylic fibers lighter in color. These infrared absorbers may be used alone or in a combination of two or more.

The particle size of the infrared absorber is preferably 2 μm or less, more preferably 1 μm or less, and even more preferably 0.5 μm or less, from the viewpoint of facilitating dispersion in the acrylic polymer that constitutes the modacrylic fibers A. In the present invention, the particle size of the infrared absorber can be measured by laser diffraction in the case of a powder, or by laser diffraction or dynamic light scattering in the case of a dispersoid dispersed in water or organic solvent (dispersion liquid).

The modacrylic fibers A may further contain a flame retardant, an auxiliary flame retardant, or a light diffusion reflective substance, inside the fibers, in addition to the infrared absorber.

There is no particular limitation on the flame retardant, and examples thereof include an antimony compound. The content of flame retardant in the modacrylic fibers A is preferably from 1 to 30% by weight, and more preferably from 2 to 20% by weight, with respect to the total weight of the fibers. If the content of antimony compound in the modacrylic fibers A is within the above-mentioned range, the production stability of the spinning process is excellent and the flame retardancy is good. Examples of the antimony compound include antimony trioxide, antimony tetroxide, antimony pentoxide, antimonic acid, sodium antimonate, and other salts of antimonic acid, and antimony oxychloride, which may be used alone or in a combination of two or more. From the viewpoint of the production stability of the spinning process, the antimony compound is preferably one or more compounds selected from the group consisting of antimony trioxide, antimony tetroxide, and antimony pentoxide.

Since a light diffusion reflective substance absorbs light in the ultraviolet region in addition to the infrared region, the arc resistance of a fabric is further improved by adding the light diffusion reflective substance. There is no particular limitation on the light diffusion reflective substance, and examples thereof include inorganic compounds such as titanium oxide and zinc oxide, and organic compounds such as triazine-based compounds, benzophenone-based compounds, and benzotriazole-based compounds. Among these, it is preferable to use titanium oxide from the viewpoint of coloration. The modacrylic fibers A contain the light diffusion reflective substance in an amount of preferably 0.3 to 10% by weight, more preferably 0.5 to 7% by weight, and even more preferably 1 to 5% by weight, with respect to the total weight of the modacrylic fibers. If the content is within the above-mentioned range, the arc resistance is improved and the texture is good.

The particle size of the light diffusion reflective substance is preferably 2 μm or less, more preferably 1.5 μm or less, and even more preferably 1 μm or less, from the viewpoint of facilitating dispersion in the acrylic polymer that constitutes the modacrylic fibers A Furthermore, in the case of titanium oxide, the particle size is preferably 0.4 μm or less, and more preferably 0.2 μm or less. There is no limitation on the particle size of an organic light diffusion reflective substance that is dissolved in organic solvent used in the production of a spinning dope. In the present invention, the particle size of the light diffusion reflective substance can be measured by laser diffraction in the case of a powder, or by laser diffraction or dynamic light scattering in the case of a dispersoid dispersed in organic solvent.

Furthermore, various additives such as a matting agent, a crystal nucleating agent, a dispersant, a lubricant, a stabilizer, a fluorescent agent, an antioxidant, an antistatic agent, and a pigment may be contained in the modacrylic fibers A as necessary to the extent that the effects of the present invention are not inhibited.

The modacrylic fibers A are preferably constituted by an acrylic polymer containing 40 to 70% by weight of acrylonitrile and 30 to 60% by weight of the other components with respect to the total weight of the acrylic polymer. If the content of acrylonitrile in the acrylic polymer is from 40 to 70% by weight, the modacrylic fibers have good thermal resistance and flame retardancy.

There is no particular limitation on the other components, as long as they can be copolymerized with acrylonitrile. Examples thereof include halogen-containing vinyl-based monomer and sulfonic acid group-containing monomer.

Examples of the halogen-containing vinyl-based monomer include halogen-containing vinyl and halogen-containing vinylidene. Examples of the halogen-containing vinyl include vinyl chloride and vinyl bromide, and examples of the halogen-containing vinylidene include vinylidene chloride and vinylidene bromide. These halogen-containing vinyl-based monomers may be used alone or in a combination of two or more. From the viewpoint of thermal resistance and flame retardancy, the arc-resistant modacrylic fibers preferably contain 30 to 60% by weight of halogen-containing vinyl-based monomer, as other components, with respect to the total weight of the acrylic polymer.

Examples of the sulfonic acid group-containing monomer include methallylsulfonic acid, allylsulfonic acid, styrenesulfonic acid, 2-acrylamide-2-methylpropanesulfonic acid, and salts thereof. In this case, examples of the salts include, but are not limited to, sodium salts such as sodium p-styrenesulfonate, potassium salts, and ammonium salts. These sulfonic acid group-containing monomers may be used alone or in a combination of two or more. Sulfonic acid group-containing monomers are used as necessary. For example, the content of sulfonic acid group-containing monomers in the acrylic polymer may be 0.5% by weight or more, and, if the content of sulfonic acid group-containing monomers in the acrylic polymer is 3% by weight or less, the production stability of the spinning process is excellent.

The acrylic polymer is preferably a copolymer obtained by copolymerizing 40 to 70% by weight of acrylonitrile, 30 to 57% by weight of halogen-containing vinyl-based monomer, and 0 to 3% by weight of sulfonic acid group-containing monomer. The acrylic polymer is more preferably a copolymer obtained by copolymerizing 45 to 65% by weight of acrylonitrile, 35 to 52% by weight of halogen-containing vinyl-based monomer, and 0 to 3% by weight of sulfonic acid group-containing monomer. The acrylic polymer is even more preferably a copolymer obtained by copolymerizing 45 to 65% by weight of acrylonitrile, 34.5 to 52% by weight of halogen-containing vinyl-based monomer, and 0.5 to 3% by weight of sulfonic acid group-containing monomer.

There is no particular limitation on the fineness of the modacrylic fibers A, but it is preferably from 1 to 20 dtex, and more preferably from 1.5 to 15 dtex, from the viewpoint of spinnability, processability, and texture and strength when formed into a woven fabric and/or a knitted fabric. Furthermore, there is no particular limitation on the fiber length of the modacrylic fibers A, but it is preferably from 38 to 127 mm, and more preferably from 38 to 76 mm, from the viewpoint of spinnability and processability. In the present invention, the fineness of the fibers is measured based on JIS L 1015.

There is no particular limitation on the strength of the modacrylic fibers A, but it is preferably from 1.0 to 4.0 cN/dtex, and more preferably from 1.5 to 3.0 cN/dtex, from the viewpoint of spinnability and processability. Furthermore, there is no particular limitation on the elongation of the modacrylic fibers A, but it is preferably from 20 to 35%, and more preferably from 20 to 25%, from the viewpoint of spinnability and processability. In the present invention, the strength and the elongation of the fibers are measured based on JIS L 1015.

The modacrylic fibers are produced by wet-spinning a spinning dope in the same way as for general modacrylic fibers, except for the addition of the infrared absorber, the light diffusion reflective substance, and the like to the acrylic polymer dissolved in the spinning dope.

The fabric according to one or more embodiments of the present invention contains the modacrylic fibers in an amount of preferably 30 to 70% by weight, more preferably 30 to 65% by weight, and even more preferably 35 to 55% by weight, with respect to the total weight of the fabric. If the content of modacrylic fibers in the fabric is within the above-mentioned range, the flame retardancy and the texture are excellent.

### Cellulosic Fibers

In one or more embodiments of the present invention, the fabric contains cellulosic fibers. The fibers enhance visibility through dyeing and provide a good texture. There is no particular limitation on the cellulosic fibers. Examples of natural cellulosic fibers include cotton, kapok, linen, ramie, and jute. The above-mentioned natural cellulosic fibers may be flame-retardant cellulose fibers obtained by subjecting natural cellulose fibers such as cotton, kapok, linen, ramie, or jute to flame-retardant treatment with a flame retardant such as N-methylol phosphonate compounds or phosphorus compounds such as tetrakis hydroxyalkyl phosphonium salts. Examples of synthetic cellulosic fibers include recycled fibers such as viscose rayon fibers and cupra fibers. The above-mentioned synthetic cellulosic fibers may be flame-retardant synthetic cellulose fibers obtained by subjecting recycled fibers such as viscose rayon fibers or cupra fibers to flame-retardant treatment with a flame retardant such as N-methylol phosphonate compounds or phosphorus compounds such as tetrakis hydroxyalkyl phosphonium salts.

These cellulosic fibers may be used alone or in a combination of two or more. From the viewpoint of strength, the cellulosic fibers each have a fiber length of preferably 15 to 51 mm, and more preferably 20 to 38 mm.

The fabric according to one or more embodiments of the present invention contains the cellulosic fibers in an amount of preferably 40 to 65% by weight, more preferably 30 to 60% by weight, and even more preferably 35 to 55% by weight, with respect to the total weight of the fabric. If the content of cellulosic fibers in the fabric is within the above-mentioned range, the fabric has excellent texture and moisture absorption properties, and further has improved durability.

Specifically, the fabric according to one or more embodiments of the present invention preferably contains 30 to 70% by weight of the modacrylic fibers A and 30 to 70% by weight of the cellulosic fibers, more preferably contains 30 to 65% by weight of the modacrylic fibers A and 35 to 70% by weight of the cellulosic fibers, even more preferably contains 35 to 60% by weight of the modacrylic fibers A and 40 to 65% by weight of the cellulosic fibers, and even more preferably contains 35 to 55% by weight of the modacrylic fibers A and 45 to 65% by weight of the cellulosic fibers, with respect to the total weight of the fabric.

### Other Fibers

In one or more embodiments of the present invention, from the viewpoint of improving the durability of the fabric, the fabric may further contain aramid fibers.

The fabric may contain the aramid fibers in an amount of 5 to 30% by weight, 5 to 25% by weight, 3 to 25% by weight, or 1 to 20% by weight, with respect to the total weight of the fabric.

Specifically, the fabric according to one or more embodiments of the present invention may contain 30 to 65% by weight of the modacrylic fibers A, 30 to 65% by weight of the cellulosic fibers, and 5 to 30% by weight of the aramid fibers, 35 to 60% by weight of the modacrylic fibers A, 35 to 60% by weight of the cellulosic fibers, and 5 to 25% by weight of the aramid fibers, 35 to 57% by weight of the modacrylic fibers A, 40 to 62% by weight of the cellulosic fibers, and 3 to 25% by weight of the aramid fibers, or 35 to 54% by weight of the modacrylic fibers A, 45 to 64% by weight of the cellulosic fibers, and 1 to 20% by weight of the aramid fibers, with respect to the total weight of the fabric.

The aramid fibers may be para-aramid fibers or meta-aramid fibers. There is no particular limitation on the fineness of the aramid fibers, but it is preferably from 1 to 20 dtex, and more preferably from 1.5 to 15 dtex, from the viewpoint of strength.

Furthermore, there is no particular limitation on the fiber length of the aramid fibers, but it is preferably from 35 to 127 mm, and more preferably from 38 to 76 mm, from the viewpoint of strength.

Furthermore, in one or more embodiments of the present invention, natural fibers, other chemical fibers such as polyimide-based fibers and polyester-based fibers, and the like may be contained in addition to the above-mentioned fibers to the extent that the effects of the present invention are not inhibited.

### Fabric

In the fabric according to one or more embodiments of the present invention, the fibers may be a spun yarn or a filament yarn. The yarn type may be selected as appropriate according to the purpose. As for fibers, for example, a fiber mixture containing the modacrylic fibers A can be spun using a known spinning method. Example of the spinning method include, but are not limited to, ring spinning, air spinning, and air jet spinning.

There is no particular limitation on the fabric, but examples thereof include a woven fabric, a knitted fabric, and a non-woven fabric. Furthermore, the fabric may be a woven fabric obtained by interweaving yarns, or a knitted fabric obtained by interknitting yarns. There is no particular limitation on the woven fabric structure, and it may be three foundation weaves such as a plain weave, a twill weave, or a satin weave, or derivative weaves using special weaving machines such as Dobby and Jacquard machines. There is no particular limitation on the knitted fabric structure, and it may be any of circular, weft, or warp knitting. The woven fabric may be a grid fabric (woven fabric) using two or more types of yarns as a warp yarn and two or more types of yarns as a weft yarn. There is no particular limitation on the method for producing the non-woven fabric, and it may be any of thermal bonding, chemical bonding, needle punching, and the like.

### Clothing Item

In one or more embodiments of the present invention, examples of the clothing item include, but are not limited to, general jumpers, jackets, down wear, vests, yakke, anoraks, coats, raincoats, shirts, athletic wear, gloves, hats, and shoes, as well as work or firefighting uniforms for people working in general roads, motorways, ports, airports, railway tracks, parking lots, oil fields, gas fields, industrial complexes, electric power plants, and the like.

Furthermore, the portion of the clothing item in which the fabric according to one or more embodiments of the present invention is used may be the entire clothing item or a portion thereof. If the fabric according to one or more embodiments of the present invention is used for a part of the clothing item, it may be used for a part of the clothing item to form a pattern such as stripes, or may be used for an entire part of the clothing item such as a sleeve, a body, a hem, or the like. Furthermore, the entire outside of the clothing item is preferably formed of the fabric according to this embodiment.

There is no particular limitation on the width of stripes when the fabric according to one or more embodiments of the present invention is used in a striped pattern, and it is preferably 50 mm or more from the viewpoint of high visibility. Furthermore, the fabric according to one or more embodiments of the present invention is preferably span the front and back of the clothing item when the clothing item is worn. For example, it is preferably used continuously from the front to the back.

There is no particular limitation on the area of the outer side of the clothing item occupied by the fabric according to one or more embodiments of the present invention in the clothing item, and it is preferably 0.14 m² or more, more preferably 0.5 m² or more, more preferably 0.8 m² or more. Particularly preferably, the entire portion of the clothing item is formed of the fabric according to one or more embodiments of the present invention.

Note that the fabric according to one or more embodiments of the present invention can be used not only for clothing items but also for tents, awnings, flags, and

### EXAMPLES

Hereinafter, the present invention will be described in detail by means of examples. However, the invention is not limited to these examples.

First, the measurement method and the evaluation method will be described.

### Visibility

### Confirmation of Conformity to “5.1 Colour Performance Requirements” of “ISO 20471:2013”

Y, x, and y of the Yxy color system were measured to determine whether or not the color was within the fluorescent yellow range, using a spectrophotometer (CM-2500C (manufactured by Konica Minolta, Inc.)) according to 5.1 of ISO 20471:2013. The brightness factor β was determined by β=Y/100, and β≥0.7 was considered as acceptable.

The conformity criteria are shown in Table 1 below.

Confirmation of Conformity to “5.2 Colour After Xenon Test” of “ISO 20471:2013” (Light Fastness)

Y, x, and y of the Yxy color system were measured after a xenon light fastness test, to determine whether or not the color was within the fluorescent yellow range, using a spectrophotometer (CM-2500C (manufactured by Konica Minolta, Inc.)) according to 5.2 Colour after Xenon test of ISO 20471:2013. The brightness factor β was determined by β=Y/100. The conformity criteria are as shown in Table 1.

### ATPV

The arc test was performed based on ASTM F1959/F1959M-12 (Standard Test Method for Determining the Arc Rating of Materials for Clothing), to obtain ATPV (cal/cm²).

### Rubbing Fastness

The rubbing fastness test was performed as follows: a test specimen was rubbed against a white cotton cloth for rubbing, and the degree of coloration of the white cotton cloth for rubbing was compared with the gray scale for staining to determine the rubbing fastness in the dry test and the wet test, based on the test method for rubbing fastness as defined in the standard JIS L 0849, using a rubbing tester.

### Production Example 1

An acrylic copolymer consisting of 51% by weight of acrylonitrile, 48% by weight of vinylidene chloride, and 1% by weight of sodium p-styrenesulfonate was dissolved in dimethylformamide to a resin concentration of 30% by weight. Then, 10 parts by weight of antimony trioxide (Sb₂O₃, product name “Patx-M” manufactured by Nihon Seiko Co., Ltd.) with respect to 100 parts by weight of the resin weight was added to the obtained resin solution, to form a spinning dope. The above-mentioned antimony trioxide was used in the form of a dispersion liquid prepared in advance by adding and uniformly dispersing 30% by weight of antimony trioxide in dimethylformamide. In the antimony trioxide dispersion liquid, the particle size of the antimony trioxide as measured by laser diffraction was 2 μm or less. The obtained spinning dope was extruded using a nozzle with a nozzle hole diameter of 0.08 mm and a number of holes of 300 into 50% by weight of dimethylformamide solution, allowed to be coagulated, washed with water, and then dried at 120° C., after which the resulting material was stretched to three times its length and heated at 145° C. for 5 minutes, and thus modacrylic fibers were obtained The obtained modacrylic fibers had a fineness of 1.71 dtex, a strength of 2.58 cN/dtex, an elongation of 27.4%, and a cut length of 51 mm. The fineness, strength, and elongation of the fibers were measured according to JIS L 1015.

### Production Example 2

In this production example, 10 parts by weight of antimony trioxide (Sb₂O₃, product name “Patx-M” manufactured by Nihon Seiko Co., Ltd.) and 10 parts by weight of antimony-doped tin oxide (product name “SN-100P” manufactured by Ishihara Sangyo Kaisha, Ltd.) with respect to 100 parts by weight of the resin weight were added to the obtained resin solution, to form a spinning dope. The above-mentioned antimony trioxide was used in the form of a dispersion liquid prepared in advance by adding and uniformly dispersing 30% by weight of antimony trioxide in dimethylformamide. In the antimony trioxide dispersion liquid, the particle size of the antimony trioxide as measured by laser diffraction was 2 μm or less. The above-mentioned antimony-doped tin oxide was used in the form of a dispersion liquid prepared in advance by adding and uniformly dispersing 30% by weight of antimony-doped tin oxide in dimethylformamide. In the antimony-doped tin oxide dispersion liquid, the particle size of the antimony-doped tin oxide as measured by laser diffraction was from 0.01 to 0.03 μm. The obtained spinning dope was extruded using a nozzle with a nozzle hole diameter of 0.08 mm and a number of holes of 300 into 50% by weight of dimethylformamide solution, allowed to be coagulated, washed with water, and then dried at 120° C., after which the resulting material was stretched to three times its length and heated at 145° C. for 5 minutes, and thus modacrylic fibers

A containing an infrared absorber were obtained. The resulting modacrylic fibers A had a fineness of 1.7 dtex, a strength of 2.5 cN/dtex, an elongation of 26%, and a cut length of 51 mm.

### Example 1

In this example, 32% by weight of the modacrylic fibers A of Production Example 2, 51% by weight of lyocell fibers (product name “Tencel” manufactured by Lenzing, with a fineness of 1.3 dtex and a fiber length of 38 mm), 10% by weight of aramid fibers (product name “Kever” manufactured DuPont, with a fineness of 1.7 dtex and a fiber length of 51 mm), and 7% by weight of the modacrylic fibers of Production Example 1 were mixed and spun through ring spinning. The resulting spun yarn was a blended yarn of English cotton count 20. The spun yarn was used to make a twill weave fabric (fabric) using a usual weaving method. The obtained fabric (with a basis weight of 5.7 oz/yd²) was subjected to the dyeing processes described in (1) through (3) below to obtain a fabric dyed fluorescent yellow.

(1) The fabric was subjected to cationic dyeing at 98° C. for 60 minutes, and then washed with water and hot water (with hot water at 20 to 40° C.). The dyeing was performed using a dyeing solution containing 2% by weight of Astrazon Flavine 10GFE 300% (manufactured by Dystar) as a cationic dye, 4% by weight of Uvitex AC Liq (manufactured by Huntsman) as a fluorescent whitening agent, 1 g/L of

Tanavol-Dap (manufactured by Tanatex) as a dye accelerant, 1 g/L of Ultra MT110 (manufactured by Mitejima Chemical Co., Ltd.) as a pH adjuster, and 1% by weight of Invalon NA (manufactured by Huntsman) as a leveling agent.

(2) The fabric after the process (1) above was subjected to reactive dyeing at 60° C. for 60 minutes using a dye and agents mentioned below, and then washed with water, soaped, and further washed with hot water (with hot water at 40 to 50° C.). The dyeing was performed using a dyeing solution containing 3% by weight of Remazol Luminus Yellow FL (manufactured by Dystar) as a reactive dye, 40 g/L of glauber's salt (sodium sulfate), and 15 g/L of soda ash (sodium carbonate).

(3) The fabric after the process (2) above was subjected to disperse dyeing at 98° C. for 15 minutes using a dye and agents mentioned below, and then washed with water, soaped, and further washed with hot water (with hot water at 40 to 50° C.). The dyeing was performed using a dyeing solution containing 0.1% by weight of Terasil Flavine 10GFF (manufactured by Dystar) as a disperse dye, 2 g/L of Tanavol-Dap (manufactured by Tanatex) as a dye accelerant, 1 g/L of acetic acid, 1 g/L of Nicca Sunsolt 7000 (manufactured by Nicca Chemical Co., Ltd.) as a dispersing and leveling agent, and 1 g/L of Nicca Sunsolt RM3406 (manufactured by Nicca Chemical Co., Ltd.).

### Example 2

A fabric (with a basis weight of 5.7 oz/yd²) was obtained in a similar way to that of Example 1, except that 41% by weight of the modacrylic fibers of Production Example 2, 35% by weight of lyocell fibers, and 24% by weight of aramid fibers were used.

### Comparative Example 1

In Comparative Example 1, a fabric (with a basis weight of 5.7 oz/yd²) was obtained in a similar way to that of Example 1, except that the fluorescent whitening agent Uvitex AC Liq (manufactured by Huntsman) was not used in the dyeing process (1) and the dyeing processes (2) and (3) were not performed.

### Comparative Example 2

In Comparative Example 2, a fabric (with a basis weight of 5.7 oz/yd²) was obtained in a similar way to that of Example 1, except that the fluorescent whitening agent Uvitex AC Liq (manufactured by Huntsman) was not used in the dyeing process (1) and the dyeing process (3) was not performed.

### Comparative Example 3

In Comparative Example 3, a fabric (with a basis weight of 5.7 oz/yd²) was obtained in a similar way to that of Comparative Example 1, except that bleaching was performed using the following agents before the dyeing process (1). The bleaching was performed using a bleaching solution containing 2% by weight of Nichilon White WX Liquid (manufactured by Nissei Kasei Co., Ltd.) as a fluorescent bleach, 1 g/L of acetic acid, 1% by weight of Soldine SK-F (scouring agent manufactured by Nissei Kasei Co., Ltd.), 5 w/v% of sodium chlorite, 3% by weight of sodium nitrate, and 2 g/L of sodium thiosulfate.

### Comparative Example 4

A fabric (with a basis weight of 5.7 oz/yd²) was obtained in a similar way to that of Example 1, except that 100% by weight of the modacrylic fibers of Production Example 1 were used.

Table 2 below shows the type and amount of fibers in the fabrics of the examples and the comparative examples.

The visibility, the arc resistance, and the rubbing fastness of the fabrics of the examples and the comparative examples were measured and evaluated as described above. Table 3 below shows the results.

TABLE 1

| | Color coordinates | | Lower limit |
|---|---|---|---|
| | x coordinate | y coordinate | value of β |
| Fluorescent | 0.387 | 0.610 | 0.70 |
| yellow | 0.356 | 0.494 | |
| | 0.398 | 0.452 | |
| | 0.460 | 0.540 | |

TABLE 2

| | Modacrylic | | | Modacrylic |
|---|---|---|---|---|
| | fibers A | | | fibers |
| | (Production | Lyocell | Aramid | (Production |
| | Example 2) | (% by | (% by | Example 1) |
| Fabric | (% by weight) | weight) | weight) | (% by weight) |
| Ex. 1 | 32 | 51 | 10 | 7 |
| Ex. 2 | 41 | 35 | 24 | 0 |
| Com.Ex. 1 | 32 | 51 | 10 | 7 |
| Com.Ex. 2 | 32 | 51 | 10 | 7 |
| Com.Ex. 3 | 32 | 51 | 10 | 7 |
| Com.Ex. 4 | 0 | 0 | 0 | 100 |

TABLE 3

| | | | | Com.Ex. | Com.Ex. | Com.Ex. | Com.Ex. |
|---|---|---|---|---|---|---|---|
| Evaluation item | | Ex. 1 | Ex. 2 | 1 | 2 | 3 | 4 |
| Conformity to | x coordinate | 0.399 | 0.396 | 0.387 | 0.393 | 0.402 | 0.383 |
| 5.1 Colour | y coordinate | 0.526 | 0.52 | 0.521 | 0.526 | 0.526 | 0.562 |
| performance | Brightness | 0.87 | 0.84 | 0.83 | 0.84 | 0.77 | 1.0 |
| requirements of | factor B | | | | | | |
| ISO 20471:2013 | Pass/Fail | Passed | Passed | Passed | Passed | Passed | Passed |
| | determination | | | | | | |
| Conformity to | x coordinate | 0.397 | 0.391 | 0.374 | 0.389 | 0.398 | 0.373 |
| 5.2 Colour | y coordinate | 0.477 | 0.465 | 0.437 | 0.475 | 0.471 | 0.46 |
| performance | Brightness | 0.71 | 0.70 | 0.67 | 0.68 | 0.66 | 0.73 |
| requirements | factor B | | | | | | |
| after Xenon light | Pass/Fail | Passed | Passed | Failed | Failed | Failed | Failed |
| fastness test of | determination | | | | | | |
| ISO 20471:2013 | | | | | | | |
| Arc resistance | ATPV | 8.2 | 8.5 | 8.2 | 8.2 | 8.2 | Torn |
| | (cal/cm²) | | | | | | |
| Rubbing fastness | Dry test | 5 | 5 | 4 | 4 | Not | Not |
| (grade) | | | | | | measured | measured |
| | Wet test | 4 | 4 | 3 | 3 | Not | Not |
| | | | | | | measured | measured |

As shown in Table 3, it is seen that the fabrics of the examples subjected to the three types of dyeing have high visibility and arc resistance, but the fabrics of Comparative Examples 1 to 3 are poor in terms of visibility after a light fastness test, and the fabric of Comparative Example 4 is poor in terms of arc resistance. Also, it is seen that the fabrics of the examples further have improved rubbing fastness.

The present invention may include, without limitation, one or more of the following embodiments, for example.

[1] A fabric containing a modacrylic fiber A and a cellulosic fiber,
wherein the modacrylic fiber A contains an infrared absorber inside the fiber, and
the fabric is dyed with at least a cationic dye, a reactive dye, and a disperse dye that are all yellow fluorescent dyes.

[2] The fabric according to [1], wherein the modacrylic fiber A contains the infrared absorber in an amount of 1 to 30% by weight with respect to the total weight of the modacrylic fiber A.

[3] The fabric according to [1] or [2], wherein the modacrylic fiber A further contains a flame retardant.

[4] The fabric according to any one of [1] to [3], wherein the modacrylic fiber A further contains a light diffusion reflective substance.

[5] The fabric according to any one of [1] to [4], wherein the fabric has an

ATPV of 8 cal/cm² or more as measured according to ASTM F1959/F1959M-12 (Standard Test Method for Determining the Arc Rating of Materials for Clothing), at a basis weight of 6.5 oz/yd² or less.

[6] The fabric according to any one of [1] to [5], wherein the fabric conforms to the standard of 5.1 Colour performance requirements of ISO 204712013 and the standard of 5.2 Colour after Xenon test of ISO 20471:2013.

[7] The fabric according to any one of [1] to [6], wherein the infrared absorber is a tin oxide-based compound.

[8] The fabric according to any one of [1] to [7], wherein the modacrylic fiber A is contained in an amount of 30 to 70% by weight with respect to the total weight of the fabric.

[9] The fabric according to any one of [1] to [8], wherein the cellulosic fiber is contained in an amount of 30 to 65% by weight with respect to the total weight of the fabric.

[10] The fabric according to any one of [1] to [7], further containing an aramid fiber in an amount of 5 to 30% by weight with respect to the total weight of the fabric.

[11] A clothing item containing the fabric according to any one of [1] to [10].

[12] A method for producing the fabric according to any one of [1] to [10], including:
dyeing a fabric containing a modacrylic fiber A and a cellulosic fiber with a cationic dye, a reactive dye, and a disperse dye that are all yellow fluorescent dyes.

1. A fabric comprising a modacrylic fiber A and a cellulosic fiber, wherein the modacrylic fiber A comprises an infrared absorber inside the fiber, and the fabric is dyed with a cationic dye, a reactive dye, and a disperse dye that are all yellow fluorescent dyes.

2. The fabric according to claim 1, wherein the modacrylic fiber A comprises the infrared absorber in an amount of 1 to 30% by weight with respect to the total weight of the modacrylic fiber A.

3. The fabric according to claim 1, wherein the modacrylic fiber A further comprises a flame retardant.

4. The fabric according to claim 1, wherein the modacrylic fiber A further comprises a light diffusion reflective substance.

5. The fabric according to claim 1, wherein the fabric has an ATPV of 8 cal/cm² or more as measured according to ASTM F1959/F1959M-12, which is a Standard Test Method for Determining the Arc Rating of Materials for Clothing, at a basis weight of 6.5 oz/yd² or less.

6. The fabric according to claim 1, wherein the fabric conforms to the standard of 5.1 Colour performance requirements of ISO 20471:2013 and the standard of 5.2 Colour after Xenon test of ISO 20471:2013.

7. The fabric according to claim 1, wherein the infrared absorber is a tin oxide-based compound.

8. The fabric according to claim 1, wherein the modacrylic fiber A is contained in an amount of 30 to 70% by weight with respect to the total weight of the fabric.

9. The fabric according to claim 1, wherein the cellulosic fiber is contained in an amount of 30 to 65% by weight with respect to the total weight of the fabric.

10. The fabric according to claim 1, further comprising an aramid fiber in an amount of 5 to 30% by weight with respect to the total weight of the fabric.

11. A clothing item comprising the fabric according to claim 1.

12. A method for producing the fabric according to claim 1, comprising:
dyeing a fabric containing a modacrylic fiber A and a cellulosic fiber with a cationic dye, a reactive dye, and a disperse dye that are all yellow fluorescent dyes.

13. The fabric according to claim 1, wherein the infrared absorber comprises one or more selected from the group consisting of antimony-doped tin oxide, indium tin oxide, niobium-doped tin oxide, phosphorus-doped tin oxide, fluorine-doped tin oxide, antimony-doped tin oxide supported on a titanium oxide substrate, iron-doped titanium oxide, carbon-doped titanium oxide, fluorine-doped titanium oxide, nitrogen-doped titanium oxide, aluminum-doped zinc oxide, and antimony-doped zinc oxide.

14. The fabric according to claim 1, wherein the fabric has a rubbing fastness of grade 4.5 or higher in a dry test as measured according to the test method for rubbing fastness defined in JIS L 0849.

15. The fabric according to claim 1, wherein the fabric has a rubbing fastness of grade 3.5 or higher in a wet test as measured according to the test method for rubbing fastness defined in JIS L 0849.
